(19) United States
(12) Patent Application Publication
(10) Pub. No.: US 2022/0204376 A1
(43) Pub. Date: Jun. 30, 2022

(54) WASTEWATER TREATMENT METHOD AND WASTEWATER TREATMENT SYSTEM

(71) Applicant: MITSUBISHI POWER ENVIRONMENTAL SOLUTIONS, LTD., Yokohama-Shi, Kanagawa (JP)

(72) Inventors: Takashi Tai, Yokohama-Shi (JP); Masaaki Anzai, Yokohama-Shi (JP); Naoki Ogawa, Tokyo (JP); Ryosuke Uehara, Tokyo (JP)

(73) Assignee: MITSUBISHI POWER ENVIRONMENTAL SOLUTIONS, LTD., Yokohama-Shi, Kanagawa (JP)

(21) Appl. No.: 17/604,012

(22) PCT Filed: Mar. 11, 2020
(86) PCT No.: PCT/JP2020/010464

§ 371 Date: Oct. 15, 2021

(30) Foreign Application Priority Data
Apr. 24, 2019 (JP) 2019-082949

(51) Int. Cl. C02F 9/00

(52) U.S. Cl. CPC C02F 9/00; C02F 2101/106

(57) ABSTRACT

The object is to provide a wastewater treatment method and a wastewater treatment system that reduce the total selenium concentration of treated water while reducing cost compared to conventional methods of removing selenium by oxidation. In the wastewater treatment method according to the present disclosure, an iron agent is added to waste water containing selenium and cyanogen to form a first coagulated substance, the first coagulated substance is removed by solid-liquid separation to obtain first treated water, a second iron agent is added to the first treated water, an acid is added to the first treated water to obtain acidic water, an oxidizing agent is added to the acidic water to oxidize the selenium, a coagulant is then added to form a second coagulated substance, and the second coagulated substance is removed by solid-liquid separation to obtain second treated water.

### TECHNICAL FIELD

The present disclosure relates to a wastewater treatment method and a wastewater treatment system for treating waste water containing selenium and cyanogen.

### BACKGROUND ART

Various hazardous components are contained in waste water drained from a power plant using coal as fuel. Thus, treatment to remove hazardous components from waste water is performed so as to meet the effluent standard.

Power generation using coal as fuel includes conventionally available coal-fired power generation and coal gasification power generation developed for increasing efficiency of power generation from coal. In the coal-fired power generation, coal is combusted in an oxidized atmosphere, and steam is produced from combustion heat and is used for power generation. In coal gasification power generation, coal is steamed under a low oxygen condition to cause a thermal decomposition reaction, and then a fuel gas is produced to be used for power generation.

Coal reaction conditions are different between the coal-fired power generation and the coal gasification power generation. The difference in the coal reaction condition affects compositions, forms, or the like of hazardous components contained in waste water. Waste water having different compositions or forms of hazardous components is required to be treated by respective suitable methods.

An exhaust gas from a coal gasifier power generation unit contains selenium (Se) and cyanogen (CN). When the exhaust gas comes into contact with water, selenium and cyanogen contained in the exhaust gas are dissolved in water. Therefore, selenium and cyanogen are contained in waste water. A part of dissolved selenium and cyanogen is present as selenocyanate ions (SeCN⁻, Se(0)). Waste water from a coal gasifier power generation unit contains a larger amount of Se(0) than waste water from a coal-fired power generation unit.

PTL 1 discloses a method of treating waste water containing selenium and cyanogen. In PTL 1, after waste water containing selenium and cyanogen is made acidic, Se(0) is oxidized by an oxidizing agent into tetravalent selenite ions (Seo₃²⁻, Se(IV)), and Se(IV) is separated and removed by coagulation sedimentation.

### CITATION LIST

### Patent Literature

[PTL 1]
   Japanese Patent Application Laid-Open No. 2018-83173
[PTL 2]
   Japanese Patent Application Laid-Open No. H9-262593

### SUMMARY OF INVENTION

### Technical Problem

If oxidation of selenium excessively proceeds, hexavalent selenate ions (SeO₄²⁻, Se(VI)) will be produced as a by-product. Unlike Se(IV), it is difficult to remove Se(VI) by coagulation sedimentation. Thus, if the by-production amount of Se(VI) increases, then it becomes difficult to reduce the overall selenium concentration below the effluent standard value. In PTL 1, Se(VI) produced as a by-product is reduced to Se(IV) by biological treatment, and then Se(IV) is removed by coagulation sedimentation.

However, to implement biological treatment, a large biological treatment water tank is required, and facility cost will be high. To implement biological treatment, a pharmaceutical for biological treatment needs to be added.

As another method for removing Se(VI), PTL 2 uses a reaction tank in which a packed bed of iron metal particles is formed, so as to reduce Se(VI) and perform coagulation sedimentation. However, iron metal particles for reduction are expensive, and the reaction tank itself is large resulting in high facility cost. Furthermore, a method of reducing Se(VI) by iron metal particles generates about 10 times more sludge than biological treatment, and thus sludge disposal cost will be high.

The present disclosure has been made in view of such circumstances and intends to provide a wastewater treatment method and a wastewater treatment system that reduce the total selenium concentration of treated water while keeping cost lower than the conventional method of removing selenium by oxidation.

### Solution to Problem

To solve the above problems, the wastewater treatment method and the wastewater treatment system of the present disclosure employ the following solutions.

The present disclosure provides a wastewater treatment method including: adding a first iron agent to waste water containing selenium and cyanogen to form a first coagulated substance and removing the first coagulated substance by solid-liquid separation to obtain first treated water; and adding a second iron agent to the first treated water, adding an acid to the first treated water to obtain acidic water, adding an oxidizing agent to the acidic water to oxidize the selenium, then adding a second coagulant to form a second coagulated substance, and removing the second coagulated substance by solid-liquid separation to obtain second treated water.

The present disclosure provides a wastewater treatment system including a first treatment section and a second treatment section. The first treatment section has a first reaction coagulation tank that stores waste water containing selenium and cyanogen, a first solid-liquid separator into which waste water from the first reaction coagulation tank flows, and a first iron agent addition unit that adds an iron agent to the first reaction coagulation tank. The second treatment section has an oxidation tank into which first treated water separated by the first solid-liquid separator flows, a second reaction coagulation tank into which water passing through the oxidation tank flows, a second solid-liquid separator into which waste water from the second reaction coagulation tank flows, an acid addition unit that adds an acid to the oxidation tank, an oxidizing agent addition unit that adds an oxidizing agent to the oxidation tank, an iron agent addition unit that adds a second iron agent to the oxidation tank, and a coagulant addition unit that adds a coagulant to the second reaction coagulation tank.

### Advantageous Effects of Invention

Addition of the first iron agent enables coagulation of Se(IV). Therefore, in the first treatment section, most of Se(IV) of selenium contained in waste water (raw water) may be removed as the first coagulated substance. Since the total selenium concentration of the first treated water becomes lower than the raw water, the amount of Se(VI) produced as a by-product by oxidation in the second treatment section can be reduced. As a result, the total selenium concentration of treated water can be reduced.

The first treatment section (the first coagulation tank and the first solid-liquid separator) is smaller than a biological treatment water tank and a reaction tank in which a packed bed of iron metal particles is formed. Thus, in the above disclosure, facility cost is reduced compared to the conventional arts. Since the produced sludge concentration is about one-tenth of the case of reduction using iron metal particles, operation cost can be reduced compared to the methods disclosed in PTL 1 and PTL 2.

### BRIEF DESCRIPTION OF DRAWINGS

FIG. 1 is a treatment flow diagram of one implementation.

FIG. 2 is a diagram illustrating a relationship between the Se^{ε+} concentration of oxidized treated water and the total selenium concentration of raw water.

FIG. 3 is a block diagram of a general configuration of a wastewater treatment system according to the present embodiment.

FIG. 4 is a schematic configuration diagram illustrating an example of a first treatment section.

FIG. 5 is a schematic configuration diagram illustrating an example of a second treatment section.

FIG. 6 is a schematic configuration diagram illustrating an example of a third treatment section.

### DESCRIPTION OF EMBODIMENTS

One embodiment of a wastewater treatment method and a wastewater treatment system according to the present disclosure will be described below with reference to the drawings.

A treatment target of the wastewater treatment method according to the present embodiment is waste water drained from a facility that gasifies fuel containing selenium in a reduction atmosphere. The fuel containing selenium may be coal, for example. The facility that gasifies fuel containing selenium in a reduction atmosphere may be a coal gasifier power generation unit, for example.

In a coal gasifier unit, coal is steamed under a reduction atmosphere to produce a fuel gas. An exhaust gas from a coal gasifier power generation unit contains selenium (Se) and cyanogen (CN). When the exhaust gas comes into contact with water, selenium and cyanogen contained in the exhaust gas are dissolved in water.

In waste water from a coal gasifier power generation unit, selenium exists in a form of selenite ions (SeO₃²⁻, Se(IV)), selenocyanate whose valence is lower than +4 (SeCN⁻, Se(0)), or the like.

In waste water from a coal gasifier power generation unit, cyanogen exists in a form of cyanogen ions (CN⁻), selenocyanate ions (SeCN⁻, Se(0)), cyanogen chloride (CNCl⁻¹), ferricyanide ions ([Fe(CN)₆]³⁻), ferrocyanide ions ([Fe(CN)₆]⁻⁴), or the like.

In addition to the above, waste water drained from a coal gasifier power generation unit may include a suspension substance (SS), arsenic (As), fluorine (F), mercury (Hg), chrome (Cr), a Biochemical Oxygen Demand (BOD) component, a COD component, ammonia (NH₃), and the like. The COD component is a persistent substance in chemical oxidation treatment.

The persistent substance here may be thiosulfuric acid, methanol, acetic acid, formic acid, benzene, benzonic acid, phenol, chlorophenol, chloroaniline, aminobenzonic acid, hydantoin, or the like.

### [Wastewater Treatment Method]

The wastewater treatment method according to the present embodiment includes a first treatment step, a second treatment step, and a third treatment step.

### [First Treatment Step]

(S1) A first iron agent is added to waste water (raw water) Wᵣ from a coal gasifier power generation unit. This reduces the pH. (S2) Next, a first alkaline agent is added to adjust the pH to be neutral, and the mixed solution is stirred for a predetermined time. Furthermore, a first coagulant aid is added, and the mixed solution is stirred for a predetermined time to form a first coagulated substance. (S3) The mixed solution is then allowed to stand still for a predetermined time to precipitate the first coagulated substance (solid), and the supernatant is separated. The above step obtains first treated water from which the first coagulated substance has been removed.

Se(IV) contained in the raw water Wᵣ is removed as the first coagulated substance by coagulation sedimentation using the first iron agent.

The first alkaline agent is sodium hydroxide, slaked lime, or the like. Herein, “neutral” means pH 6 to pH 9.

The first iron agent is an iron compound and serves as a coagulant for Se(IV). The first iron agent is ferric chloride, poly-iron, or the like. For example, when ferric chloride is used as the first iron agent, the addition amount of ferric chloride is greater than or equal to 10 mg/L and less than or equal to 200 mg/L, preferably greater than or equal to 20 mg/L and less than or equal to 50 mg/L as iron (Fe).

A polymer coagulant is used for the first coagulant aid. The polymer coagulant is an anion-based polymer coagulant, a nonion-based polymer coagulant, or the like. The anion-based polymer coagulant is, for example, Hishifloc H-305 (by Mitsubishi Hitachi Power Systems Environmental Solutions, Ltd.), Hishifloc H-410 (by Mitsubishi Hitachi Power Systems Environmental Solutions, Ltd.), Hishifloc HA-510 (by Mitsubishi Hitachi Power Systems Environmental Solutions, Ltd.), or the like.

### [Second Treatment Step]

(S4) First, a second iron agent is added to the first treated water. (S5) Next, an acid is added to adjust the pH to be acidic. (S6) an oxidizing agent is added to the acidized first treated water (acidic water), and the mixed solution is stirred for a predetermined time. (S7) After a predetermined time elapsed, a second coagulant is added, and the mixed solution is stirred for a predetermined time to form a second coagulated substance. A second coagulant aid may be added after the addition of the second coagulant. (S8) Next, a second alkaline agent is added to adjust the pH to be neutral. (S9) The mixed solution is then allowed to stand still for a predetermined time to precipitate the coagulated substance, and the supernatant is separated. The above step obtains second treated water from which the second coagulated substance has been removed.

In the above (S4) to (S6), selenium whose valence is lower than +4 is oxidized into selenium whose valence is +4. Selenium whose valence is lower than +4 such as Se(0) and Se(−II) contained in the raw water Wᵣ is oxidized into Se(IV). Se(IV) can be removed by coagulation sedimentation.

The second iron agent is ferric chloride, poly-iron, or the like. When ferric chloride is used as the second iron agent, the addition amount of ferric chloride is greater than or equal to 50 mg/L and less than or equal to 1000 mg/L, preferably greater than or equal to 200 mg/L and less than or equal to 500 mg/L, particularly preferably greater than or equal to 300 mg/L and less than or equal to 400 mg/L as iron (Fe). The timing of adding the second iron agent is not limited to the above and may be before or after the addition of the acid or may be after addition of the oxidizing agent. The second iron agent has a role as a coagulant that promotes coagulation of the solid content and, at the same time, has a role of assisting in maintaining a suitable oxidation-reduction potential.

The acid is sulfuric acid, chloric acid, nitric acid, or the like. The pH of acidic water is adjusted to be greater than or equal to 1 and less than 7, preferably greater than or equal to 3 and less than or equal to 6, more preferably 4. The acidic water is adjusted before the addition of the oxidizing agent, so as to set up an environment in which the oxidizing agent is likely to act.

The oxidizing agent is selected from hydrogen peroxide, hypochlorous acid, permanganic acid, peroxomonosulfuric acid, peroxodisulfuric acid, or ozone. The oxidizing agent is preferably hydrogen peroxide in particular. The addition amount of the oxidizing agent is suitably set in accordance with the cyanogen concentration, the selenium concentration, or the like in the raw water. The oxidizing agent oxidizes selenium whose valence is lower than +4.

When hydrogen peroxide is used as the oxidizing agent, the addition amount of hydrogen peroxide is greater than or equal to 20 mg/L, preferably greater than or equal to 40 mg/L and less than or equal to 200 mg/L, particularly preferably greater than or equal to 50 mg/L and less than or equal to 150 mg/L. If the addition amount of hydrogen peroxide is excessively small, oxidation of selenium will insufficiently proceed, and selenium whose valence is lower than +4 (for example, SeCN⁻) will remain. On the other hand, excessive addition of hydrogen peroxide will increase the amount of a by-product of Se(VI). The suitable addition amount of hydrogen peroxide varies in accordance with the selenium concentration whose valence is less than +4.

When sodium hypochlorite is used as the oxidizing agent, the addition amount of sodium hypochlorite is greater than or equal to 200 mg/L and less than or equal to 800 mg/L, preferably greater than or equal to 200 mg/L and less than or equal to 500 mg/L. If the addition amount of sodium hypochlorite is excessively small, oxidation of selenium will insufficiently proceed, and selenium whose valence is lower than +4 (for example, SeCN⁻) will remain. On the other hand, excessive addition of sodium hypochlorite will result in an excessively high oxidation-reduction potential of acidic waste water. The excessively high oxidation-reduction potential of the acidic waste water will facilitate an oxidation reaction of selenium and increase Se(VI). This then makes it difficult to remove selenium.

The oxidation-reduction potential of the acidic water can be controlled so that the acidic water becomes a solution having an oxidizing tendency. Specifically, the oxidation-reduction potential of the acidic water is greater than or equal to 200 mV and less than or equal to 1500 mV, preferably greater than or equal to 200 mV and less than or equal to 1000 mV, more preferably greater than or equal to 400 mV and less than or equal to 500 mV. The oxidation-reduction potential may be adjusted by utilizing the oxidizing agent, the second iron agent, or both of the oxidizing agent and the second iron agent.

The second alkaline agent is sodium hydroxide, slaked lime, or the like. Herein, “neutral” means pH 6 to pH 9.

An inorganic coagulant is used for the second coagulant. A polymer coagulant is used as the second coagulant aid. The “second coagulant” means a coagulant used in the second treatment step.

The inorganic coagulant is polyaluminum chlorate (PAC), aluminum sulfate, an iron agent (ferric chloride), or the like. One type or two or more types of inorganic coagulants may be added.

The polymer coagulant is an anion-based polymer coagulant, a nonion-based polymer coagulant, or the like. The anion-based polymer coagulant is, for example, Hishifloc H-305 (by Mitsubishi Hitachi Power Systems Environmental Solutions, Ltd.), Hishifloc H-410 (by Mitsubishi Hitachi Power Systems Environmental Solutions, Ltd.), Hishifloc HA-510 (by Mitsubishi Hitachi Power Systems Environmental Solutions, Ltd.), or the like.

In the second treatment step, a step of removing another hazardous substance can be performed in parallel. For example, fluorine (F) removal treatment requires a coagulation and separation step using a coagulant in general. Therefore, when coagulation and solid-liquid separation are performed on selenium, the fluorine removal treatment can be performed in parallel.

### [Third Treatment Step]

(S10) First, a chelating agent is added to the second treated water, and the mixed solution is stirred for a predetermined time. (S11) Next, a third iron agent is added, and (S12) next, a third coagulant is added. This reduces the pH of the mixed solution. (S13) Next, a third alkaline agent is added to adjust the pH to be neutral. The mixed solution is stirred for a predetermined time to form a third coagulated substance. After the third alkaline agent is added, a third coagulant aid may be added, and the mixed solution may be further stirred. (S14) The mixed solution is then allowed to stand still for a predetermined time to precipitate the third coagulated substance, and supernatant is separated. The above step obtains third treated water from which the third coagulated substance has been removed.

The chelating agent is Epofloc (a registered trademark) L-1 (by MIYOSHI OIL & FAT CO., LTD.) or the like. By adding the chelating agent, it is possible to perform removal treatment of a heavy metal such as mercury in parallel. Addition of chelating agent may be omitted.

The third iron agent is ferric chloride, poly-iron, or the like. When ferric chloride is used, the addition amount of the third iron agent is greater than or equal to 10 mg/L and less than or equal to 1000 mg/L, preferably greater than or equal to 20 mg/L and less than or equal to 200 mg/L, more preferably greater than or equal to 20 mg/L and less than or equal to 50 mg/L as iron (Fe). Excessive addition of the third iron agent will increase a sediment as Fe(OH)₃, and thus is not preferable because of increased sludge to be industrial waste.

The third alkaline agent is sodium hydroxide, slaked lime, or the like. Herein, “neutral” means pH 6 to pH 9.

An inorganic coagulant is used for the third coagulant. A polymer coagulant is used as the third coagulant aid.

The inorganic coagulant and the polymer coagulant can be selected from those illustrated as examples in the above second treatment step.

By adding the third coagulant to the second treated water and then performing treatment, it is possible to remove Se(IV) remaining in the second treated water.

According to the wastewater treatment method of the present embodiment, before the oxidation treatment of selenium, Se(IV) is coarsely removed by coagulation sedimentation using the first iron agent. Se(VI) is not produced as a by-product by this coagulation sedimentation. The total selenium concentration of the first treated water decreases below that of the raw water, which can reduce the amount of Se(VI) produced as a by-product when selenium is oxidized. As a result, the total selenium concentration of the second treated water can be reduced.

Furthermore, by removing selenium through two separate steps of the second treatment step and the third treatment step, it is possible to reduce the total selenium concentration of the final treated water (third treated water) to a desired value (effluent standard) while controlling by-production of Se(VI) due to oxidation.

### [Test 1]

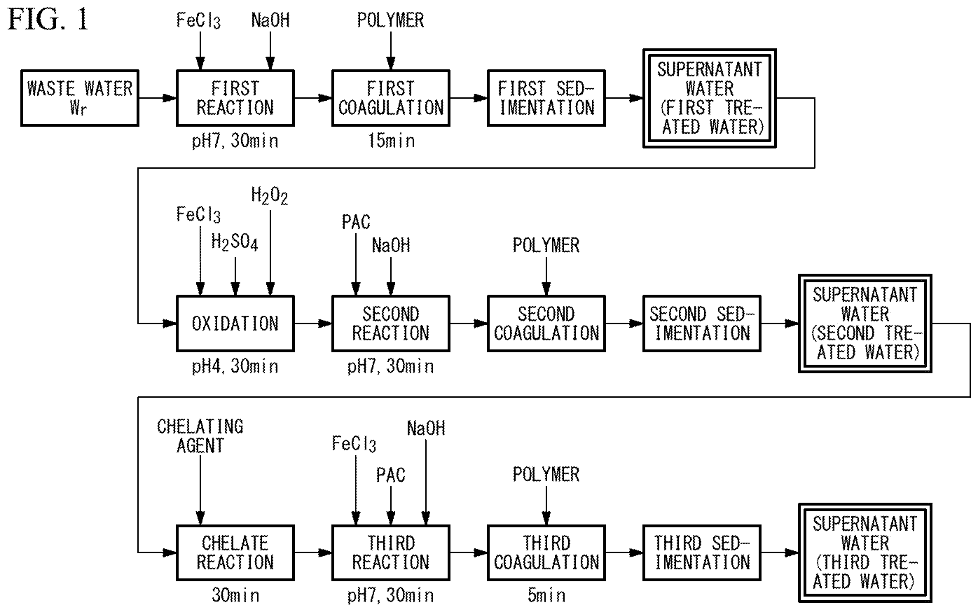

A wastewater treatment test was performed in accordance with the embodiment described above. A treatment flow is illustrated in FIG. 1.

In this test, IGCC-derived waste water having a selenium concentration of about 6 mg/L was used as the treatment target.

First treatment step: (first reaction→first coagulation→first sedimentation→first treated water)

Ferric chloride (FeCl₃) was added to waste water (raw water) Wᵣ, sodium hydroxide (NaOH) was further added to obtain a solution of pH 7 (neutral water), and the solution was stirred for 30 minutes. The addition amount of FeCl₃ as Fe was 50 mg/L.

Next, a polymer (Hishifloc H-410) was added, and the mixed solution was stirred for 15 minutes to form the first coagulated substance. The mixed solution was then allowed to stand still to precipitate the first coagulated substance, and the supernatant water (first treated water) was separated. The addition amount of the polymer was 2 mg/L.

### Second Treatment Step:

The ferric chloride (FeCl₃) and sulfuric acid (H₂SO₄) were added to the first treated water to prepare a solution of pH 4 (acidic waste water). An oxidizing agent (H₂O₂) was added to the acidic waste water, and the mixed solution was stirred for 30 minutes. The addition amount of FeCl₃ as Fe was 350 mg/L. The addition amount of H₂O₂ was 70 mg/L. The oxidation-reduction potential (ORP) of the acidic waste water was about 400 to 450 my.

After stirring, PAC was added to the acidic waste water, and the mixed solution was stirred for 30 minutes. Then, NaOH was added to obtain a solution of pH 7 (neutral water). The addition amount of PAC was 6000 mg/L. The addition of PAC enables fluorine (F) treatment to be performed in parallel.

Next, a polymer (Hishifloc H-410) was added to neutral water, and the mixed solution was stirred for 15 minutes to form a second coagulated substance. The addition amount of polymer was 5 mg/L. The mixed solution was then allowed to stand still to precipitate the second coagulated substance, and the supernatant water (second treated water) was separated.

### Third Treatment Step:

A chelating agent (Epofloc (a registered trademark) L-1) was added to the second treated water, and the mixed solution was stirred for 30 minutes. The addition amount of the chelating agent was 10 mg/L.

Then, ferric chloride (FeCl₃) and PAC were sequentially added, then NaOH was added to obtain a solution of pH 7 (neutral water), and the solution was stirred for 30 minutes. The addition amount of FeCl₃ as Fe was 50 mg/L. The addition amount of PAC was 3000 mg/L. The addition of PAC enables fluorine (F) treatment to be performed in parallel.

A polymer (Hishifloc H-410) was added to the neutral water containing PAC, and the mixed solution was stirred for 5 minutes to form the third coagulated substance. The addition amount of the polymer was 10 mg/L. The mixed solution was then allowed to stand still to precipitate the third coagulated substance, and the supernatant water (third treated water) was separated.

The concentrations of total selenium (T-Se) and dissolved selenium (Se, Se⁴⁺, Se⁶⁺ as SeCN) were measured for the raw water, the first treated water, the second treated water, and the third treated water. The measurement was performed by ion chromatography.

Table 1 illustrates measurement results.

TABLE 1

(mg-Se/L)

| | T-Se | SeCN | Se⁴⁺ | Se⁶⁺ |
|---|---|---|---|---|
| Raw water | 6.05 | 3.02 | 3.03 | |
| First treated water | 3.41 | 3.02 | 0.39 | 0.00 |
| Second treated water | 0.23 | 0.05 | 0.13 | 0.05 |
| Third treated water | 0.10 | 0.04 | 0.01 | 0.05 |

According to Table 1, it was confirmed that a large amount of Se⁴⁺ (Se(IV)) was removed by the first treatment and the concentration of SeCN (Se(0)) was not substantially changed by the first treatment. No Se^{ε+} (Se(VI)) was produced by the first treatment. In the second treatment, Se(IV) and the most part of Se(0) were removed. Se(IV) remaining in the second treated water was substantially removed by the third treatment.

### [Test 2]

Next, only the second treatment step and the third treatment step were performed using raw water derived from the same source as the raw water of Table 1. The following indicates the selenium concentration of treated water (the second treated water and the third treated water).

TABLE 2

(mg-Se/L)

| | T-Se | SeCN | Se⁴⁺ | Se⁶⁺ |
|---|---|---|---|---|
| Raw water | 6.05 | 3.02 | 3.03 | |
| Second treated water | 0.28 | 0.08 | 0.12 | 0.08 |
| Third treated water | 0.17 | 0.08 | 0.01 | 0.08 |

According to Table 2, because the first treatment was not performed, the amount of Se(VI) in the second treated water was larger than that in Table 1, and the total selenium (T-Se) concentration of the third treated water was also higher.

### [Test 3]

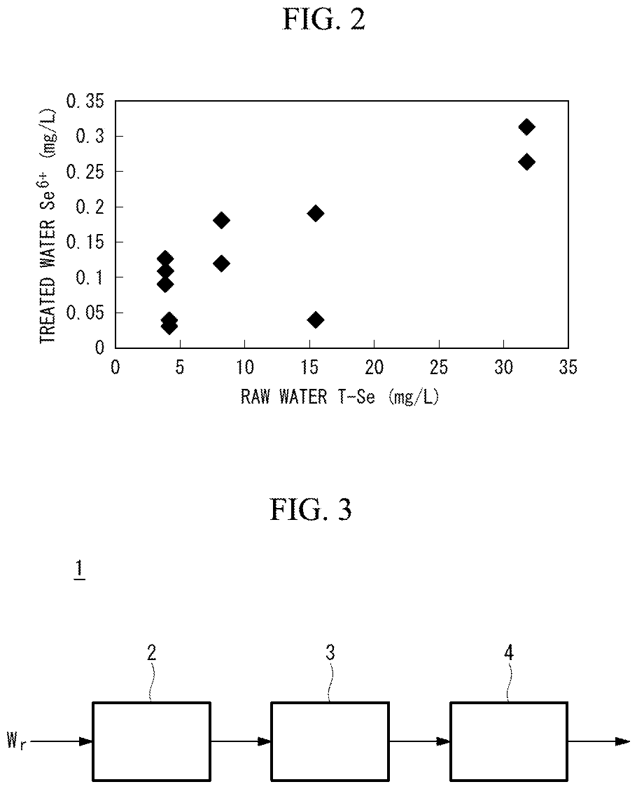

FIG. 2 illustrates the relationship between the Se⁶⁺ concentration of the treated water for which only the second treatment was performed (second treated water) and the total selenium concentration of the raw water.

According to FIG. 2, when the total selenium concentration of the raw water was higher, the amount of Se(VI) increased in the second treated water. This revealed that, in oxidation treatment of selenium, the total selenium concentration of the raw water has a correlation with Se(VI) produced by the oxidation treatment.

According to the results of Test 1 and Test 2, it is difficult to remove Se(VI) produced by the oxidation treatment (second treatment step) by the subsequent coagulation sedimentation. Therefore, when performing oxidation treatment on raw water having a high total selenium concentration, it is important to reduce in advance the total selenium concentration of the raw water.

The amount of selenium contained in coal differs depending on the place of production. Conventionally, coal with a low selenium content has been selected and used for fuel of coal gasifier power generation systems. In contrast, when Se(IV) is coarsely removed by the first treatment step, it is possible to raise the acceptable upper limit of the selenium content, and therefore, more options of usable coal are available.

### [Wastewater Treatment System]

Next, a wastewater treatment system that can perform the above wastewater treatment method will be described. Although not illustrated, the wastewater treatment system according to the present embodiment is incorporated in a part of a wastewater treatment mechanism of a coal gasifier power generation unit.

FIG. 3 illustrates a block diagram of a general configuration of a wastewater treatment system 1 according to the present embodiment. The wastewater treatment system 1 has a first treatment section 2 that treats waste water drained from a coal gasifier power generation unit (raw water Wᵣ, e.g. scrubber waste water), a second treatment section 3 that is connected downstream of the first treatment section 2 and treats waste water drained from the first treatment section 2, and a third treatment section 4 that is connected downstream of the second treatment section 3 and treats waste water drained from the second treatment section 3.

### [First Treatment Section]

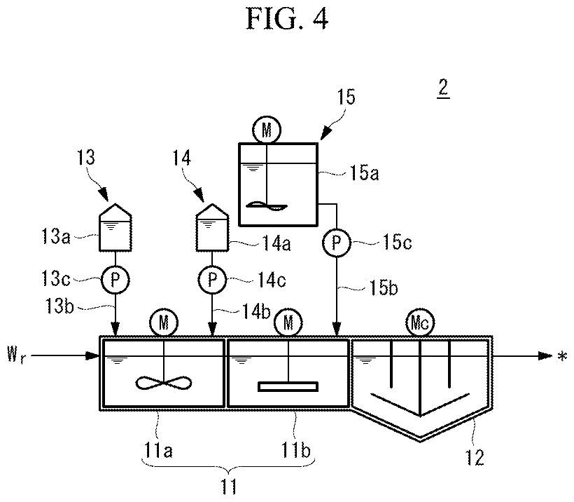

FIG. 4 illustrates a schematic configuration diagram of the first treatment section 2.

The first treatment section 2 has a first reaction coagulation tank 11, a first sedimentation tank (a first solid-liquid separator) 12, a first iron agent addition unit 13, a first alkaline addition unit 14, and a first coagulant aid addition unit 15.

The first reaction coagulation tank 11 is formed of a first reaction chamber 11a and a first coagulation chamber 11b. The first reaction chamber 11a and the first coagulation chamber 11b can store water therein independently. The first reaction chamber 11a and the first coagulation chamber 11b are connected such that water stored in the first reaction chamber 11a can flow into the first coagulation chamber 11b. The first reaction chamber 11a receives waste water (raw water) Wᵣ drained from the coal gasifier power generation unit. The first coagulation chamber 11b receives waste water from the first reaction chamber 11a.

The first reaction coagulation tank 11 and the first sedimentation tank 12 are connected such that water stored in the first reaction coagulation tank 11 (the first coagulation chamber 11b in FIG. 4) can flow in the first sedimentation tank 12. The first sedimentation tank 12 has a drain port (not illustrated) used for draining separated supernatant water (first treated water).

The first iron agent addition unit 13 and the first alkaline addition unit 14 are connected to the first reaction chamber 11a.

The first iron agent addition unit 13 is formed of a tank 13a in which the first iron agent is stored, a pipe 13b connected between the tank 13a and the first reaction chamber 11a, and a pump 13c that is installed in the middle of the pipe 13b and feeds the first iron agent to the first reaction chamber 11a. The first iron agent addition unit 13 can add the first iron agent to the raw water Wᵣ stored in the first reaction chamber 11a.

The first alkaline addition unit 14 is formed of a tank 14a in which the first alkaline agent is stored, a pipe 14b connected between the tank 14a and the first reaction chamber 11a, and a pump 14c that is installed in the middle of the pipe 14b and feeds the first alkaline agent to the first reaction chamber 11a. The first alkaline addition unit 14 can add the first alkaline agent to the raw water Wᵣ stored in the first reaction chamber 11a.

A mixer M is installed in the first reaction chamber 11a. The mixer M can stir water stored in the first reaction chamber 11a. In the first reaction chamber 11a, a pH measuring device (not illustrated) that measures the pH of water stored in the first reaction chamber 11a may be installed.

The first coagulant aid addition unit 15 is connected to the first coagulation chamber 11b. In FIG. 4, the first coagulant aid addition unit 15 is formed of a tank 15a in which the first coagulant aid is stored, a pipe 15b connected between the tank 15a and the first coagulation chamber 11b, and a pump 15c that is installed in the middle of the pipe 15b and feeds the first coagulant aid to the first coagulation chamber 11b. The first coagulant aid addition unit 15 can add the first coagulant aid to water stored in the tank 15a.

A mixer M is installed in the first coagulation chamber 11b. The mixer M can stir water stored in the first coagulation chamber 11b.

The first sedimentation tank 12 has a shape recessed in the bottom and is configured to perform solid-liquid separation in a stationary state. A mixer M_{c} of sludge scraping and collecting type is installed in the first sedimentation tank 12. The mixer M_{c} can scrape and collect sedimentation sludge to the recess at the center of the first sedimentation tank 12.

### [Second Treatment Section]

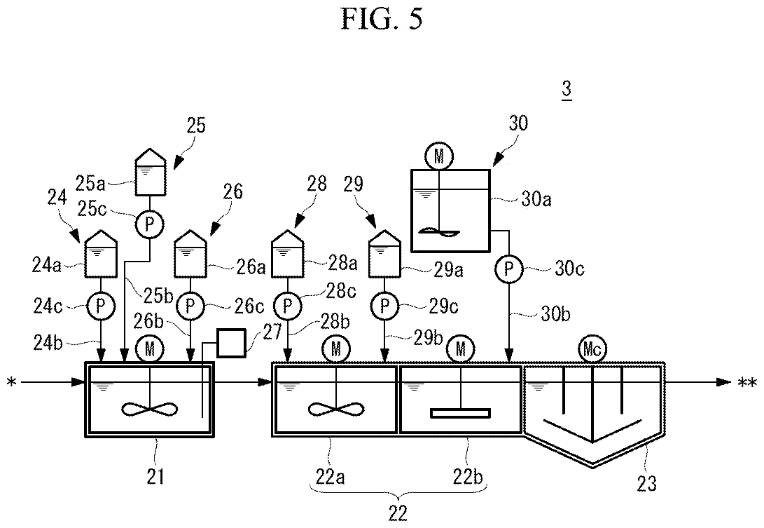

FIG. 5 illustrates a schematic configuration diagram of the second treatment section 3.

The second treatment section 3 has an oxidation tank 21, a second reaction coagulation tank 22, a second sedimentation tank (a second solid-liquid separator) 23, a second iron agent addition unit 24, an acid addition unit 25, an oxidizing agent addition unit 26, a second alkaline addition unit 28, a second coagulant addition unit (a coagulant addition unit) 29, and a second coagulant aid addition unit 30.

The oxidation tank 21 can receive and store waste water (first treated water) from the first sedimentation tank 12. The oxidation tank 21 has a drain port (not illustrated) used for draining water stored in the oxidation tank 21.

The second iron agent addition unit 24, the acid addition unit 25, and the oxidizing agent addition unit 26 are connected to the oxidation tank 21.

The second iron agent addition unit 24 has a tank 24a in which the second iron agent is stored, a pipe 24b connected between the tank 24a and the oxidation tank 21, and a pump 24c that is installed in the middle of the pipe 24b and feeds the second iron agent to the oxidation tank 21. The second iron agent addition unit 24 can add the second iron agent to water stored in the oxidation tank 21.

The acid addition unit 25 has a tank 25a in which an acid is stored, a pipe 25b connected between the tank 25a and the oxidation tank 21, and a pump 25c that is installed in the middle of the pipe 25b and feeds the acid to the oxidation tank 21. The acid addition unit 25 can add an acid to water stored in the oxidation tank 21.

The oxidizing agent addition unit 26 has a tank 26a in which an oxidizing agent is stored, a pipe 26b connected between the tank 26a and the oxidation tank 21, and a pump 26c that is installed in the middle of the pipe 26b and feeds the oxidizing agent to the oxidation tank 21. The oxidizing agent addition unit 26 can add an oxidizing agent to water stored in the oxidation tank 21.

A mixer M may be installed in the oxidation tank 21 so that the mixer M can stir water stored in the oxidation tank 21. In the oxidation tank 21, a pH measuring device (not illustrated) that measures the pH of water stored in the oxidation tank 21 may be installed. In the oxidation tank 21, an oxidation-reduction potential measuring device 27 that measures the oxidation-reduction potential of water stored in the oxidation tank 21 may be installed.

The second reaction coagulation tank 22 is formed of a second reaction chamber 22a and a second coagulation chamber 22b. The second reaction chamber 22a and the second coagulation chamber 22b are tanks that can store water therein. The second reaction chamber 22a and the second coagulation chamber 22b are connected so that water stored in the second reaction chamber 22a can flow into the second coagulation chamber 22b. The second reaction chamber 22a receives waste water drained from the oxidation tank 21. The second coagulation chamber 22b receives waste water from the second reaction chamber 22a.

The second reaction coagulation tank 22 and the second sedimentation tank 23 are connected so that water stored in the second reaction coagulation tank 22 (the second coagulation chamber 22b in FIG. 5) can flow into the second sedimentation tank 23. The second sedimentation tank 23 has a drain port (not illustrated) used for draining supernatant water separated by sedimentation (second treated water).

The second alkaline addition unit 28 and the second coagulant addition unit 29 are connected to the second reaction chamber 22a.

The second alkaline addition unit 28 is formed of a tank 28a in which the second alkaline agent is stored, a pipe 28b connected between the tank 28a and the second reaction chamber 22a, and a pump 28c that is installed in the middle of the pipe 28b and feeds the second alkaline agent to the second reaction chamber 22a. The second alkaline addition unit 28 can add the second alkaline agent to water stored in the second reaction chamber 22a.

The second coagulant addition unit 29 is formed of a tank 29a in which the second coagulant is stored, a pipe 29b connected between the tank 29a and the second reaction chamber 22a, and a pump 29c that is installed in the middle of the pipe 29b and feeds the second coagulant to the second reaction chamber 22a. The second coagulant addition unit 29 can add the second coagulant to water stored in the second reaction chamber 22a. The term “second” used in the “second coagulant addition unit” means that the unit is an element forming the second treatment section. The “second coagulant” means that the coagulant is added from the second coagulant addition unit.

A mixer M is installed in the second reaction chamber 22a. The mixer M can stir water stored in the second reaction chamber 22a. In the second reaction chamber 22a, a pH measuring device (not illustrated) that measures the pH of water stored in the second reaction chamber 22a may be installed.

The second coagulant aid addition unit 30 is connected to the second coagulation chamber 22b. The second coagulant aid addition unit 30 is formed of a tank 30a in which the second coagulant aid is stored, a pipe 30b connected between the tank 30a and the second coagulation chamber 22b, and a pump 30c that is installed in the middle of the pipe 30b and feeds the second coagulant to the second coagulation chamber 22b. The second coagulant aid addition unit 30 can add the second coagulant aid to water stored in the tank.

A mixer M is installed in the second coagulation chamber 22b. The mixer M can stir water stored in the second coagulation chamber 22b.

The second sedimentation tank 23 has a shape recessed in the bottom and is configured to perform solid-liquid separation in a stationary state. A mixer M_{c} of sludge scraping and collecting type is installed in the second sedimentation tank 23. The mixer M_{c} can scrape and collect sedimentation sludge to the recess at the center of the second sedimentation tank 23.

### [Third Treatment Section]

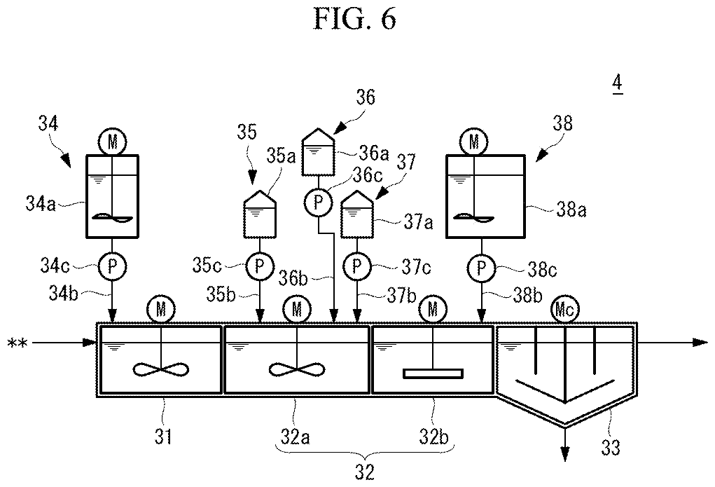

FIG. 6 illustrates a schematic configuration diagram of the third treatment section 4.

The third treatment section 4 has a chelate reaction tank 31, a third reaction coagulation tank 32, a third sedimentation tank (a third solid-liquid separator) 33, a chelating agent addition unit 34, a third iron agent addition unit 35, a third coagulant addition unit 36, a third alkaline addition unit 37, and a third coagulant aid addition unit 38.

The chelate reaction tank 31 can receive and store the second treated water from the second sedimentation tank 23.

The chelating agent addition unit 34 is connected to the chelate reaction tank 31. The chelate reaction tank 31 has a drain port (not illustrated) used for draining water stored in the chelate reaction tank 31.

The chelating agent addition unit 34 is formed of a tank 34a in which the chelating agent is stored, a pipe 34b connected between the tank 34a and the chelate reaction tank 31, and a pump 34c that is installed in the middle of the pipe 34b and feeds the chelating agent to the chelate reaction tank 31. The chelating agent addition unit 34 can add the chelating agent to water stored in the chelate reaction tank 31.

The third reaction coagulation tank 32 is formed of a third reaction chamber 32a and a third coagulation chamber 32b. The third reaction chamber 32a and the third coagulation chamber 32b are tanks that can store water therein. The third reaction chamber 32a and the third coagulation chamber 32b are connected so that water stored in the third reaction chamber 32a can flow into the third coagulation chamber 32b. The third reaction chamber 32a receives waste water drained from the chelate reaction tank 31. The third coagulation chamber 32b receives waste water from the third reaction chamber 32a.

The third reaction coagulation tank 32 and the third sedimentation tank 33 are connected so that water stored in the third reaction coagulation tank 32 (the third coagulation chamber 32b in FIG. 6) can flow into the third sedimentation tank 33. The third sedimentation tank 33 has a drain port (not illustrated) used for draining supernatant water (third treated water) separated by sedimentation.

The third iron agent addition unit 35, the third coagulant addition unit 36, and the third alkaline addition unit 37 are connected to the third reaction chamber.

The third iron agent addition unit 35 is formed of a tank 35a in which the third iron agent is stored, a pipe 35b connected between the tank 35a and the third reaction chamber 32a, and a pump 35c that is installed in the middle of the pipe 35b and feeds the third iron agent to the third reaction chamber 32a. The third iron agent addition unit 35 can add the third iron agent to water stored in the third reaction chamber 32a.

The third alkaline addition unit 37 is formed of a tank 37a in which the third alkaline agent is stored, a pipe 37b connected between the tank 37a and the third reaction chamber 32a, and a pump 37c that is installed in the middle of the pipe 37b and feeds the third alkaline agent to the third reaction chamber 32a. The third alkaline addition unit can add the third alkaline agent to water stored in the third reaction chamber 32a.

The third coagulant addition unit 36 is formed of a tank 36a in which the third coagulant is stored, a pipe 36b connected between the tank 36a and the third reaction chamber 32a, and a pump 36c that is installed in the middle of the pipe 36b and feeds the third coagulant to the third reaction chamber 32a. The third coagulant addition unit can add the third coagulant to water stored in the third reaction chamber 32a.

A mixer M is installed in the third reaction chamber 32a. The mixer M can stir water stored in the third reaction chamber 32a.

The third coagulant aid addition unit 38 is connected to the third coagulation chamber 32b. The third coagulant aid addition unit 38 is formed of a tank 38a in which the third coagulant aid is stored, a pipe 38b connected between the tank 38a and the third coagulation chamber 32b, and a pump 38c that is installed in the middle of the pipe 38b and feeds the third coagulant to the third coagulation chamber 32b. The third coagulant aid addition unit 38 can add the third coagulant to water stored in the tank 38a.

A mixer M is installed in the third coagulation chamber 32b. The mixer M can stir water stored in the third coagulation chamber 32b.

The third sedimentation tank 33 has a shape recessed in the bottom and is configured to perform solid-liquid separation in a stationary state. A mixer M_{c} of sludge scraping and collecting type is installed in the third sedimentation tank 33. The mixer M_{c} can scrape and collect sedimentation sludge to the recess at the center of the third sedimentation tank 33.

### REFERENCE SIGNS LIST

1 wastewater treatment system
2 first treatment section
3 second treatment section
4 third treatment section
11 first reaction coagulation tank
11a first reaction chamber
11b first coagulation chamber
12 first sedimentation tank (first solid-liquid separator)
13 first iron agent addition unit
13a, 14a, 15a, 24a, 25a, 26a, 28a, 29a, 30a, 34a, 35a, 36a, 37a, 38a tank
13b, 14b, 15b, 24b, 25b, 26b, 28b, 29b, 30b, 34b, 35b, 36b, 37b, 38b pipe
13c, 14c, 15c, 24c, 25c, 26c, 28c, 29c, 30c, 34c, 35c, 36c, 37c, 38c pump
14 first alkaline addition unit
15 first coagulant aid addition unit
21 oxidation tank
22 second reaction coagulation tank
22a second reaction chamber
22b second coagulation chamber
23 second sedimentation tank (second solid-liquid separator)
24 second iron agent addition unit
25 acid addition unit
26 oxidizing agent addition unit
27 oxidation-reduction potential measuring device
28 second alkaline addition unit
29 second coagulant addition unit (coagulant addition unit)
30 second coagulant aid addition unit
31 chelate reaction tank
32 third reaction coagulation tank
32a third reaction chamber
32b third coagulation chamber
33 third sedimentation tank (third solid-liquid separator)
34 chelating agent addition unit
35 third iron agent addition unit
36 third coagulant addition unit
37 third alkaline addition unit
38 third coagulant aid addition unit

1. A wastewater treatment method comprising:
adding a first iron agent to waste water containing selenium and cyanogen to form a first coagulated substance and removing the first coagulated substance by solid-liquid separation to obtain first treated water; and
adding a second iron agent to the first treated water, adding an acid to the first treated water to obtain acidic water, adding an oxidizing agent to the acidic water to oxidize the selenium, then adding a coagulant to form a second coagulated substance, and removing the second coagulated substance by solid-liquid separation to obtain second treated water.

2. A wastewater treatment system comprising:
a first treatment section; and
a second treatment section,
wherein the first treatment section includes a first reaction coagulation tank that stores waste water containing selenium and cyanogen, a first solid-liquid separator into which waste water from the first reaction coagulation tank flows, and a first iron agent addition unit that adds an iron agent to the first reaction coagulation tank, and
wherein the second treatment section includes an oxidation tank into which first treated water separated by the first solid-liquid separator flows, a second reaction coagulation tank into which water passing through the oxidation tank flows, a second solid-liquid separator into which waste water from the second reaction coagulation tank flows, an acid addition unit that adds an acid to the oxidation tank, an oxidizing agent addition unit that adds an oxidizing agent to the oxidation tank, a second iron agent addition unit that adds an iron agent to the oxidation tank, and a coagulant addition unit that adds a coagulant to the second reaction coagulation tank.
